(19) United States
(12) Patent Application Publication
(10) Pub. No.: US 2009/0021826 A1
(43) Pub. Date: Jan. 22, 2009

(54) MICROSCOPE WITH AN EXTERNAL POWER SUPPLY UNIT

(75) Inventors: Ralph Aschenbach, Hardegsen-Hevensen (DE); Thomas Bocher, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl ZeissMicsolmaging GmbH

(21) Appl. No.: 11/920,289

(22) PCT Filed: Jun. 22, 2006
(86) PCT No.: PCT/EP2006/005219

§ 371 Date: Nov. 13, 2007

(30) Foreign Application Priority Data
Jun. 22, 2005 (DE) 102005029673.4

(51) Int. Cl. G02B 21/00

(52) U.S. Cl. 359/368

(57) ABSTRACT

The invention is directed to a light microscope with an external power supply unit. The microscope according to the invention has a receptacle for the external power supply unit in which it can be fastened in a removable manner. This receptacle is advantageously formed as a cutout in the microscope stand so that the power supply unit adapts to the outer shape of the microscope when seated in the receptacle.

### CROSS-REFERENCE TO RELATED APPLICATIONS

This application claims priority of International Application No. PCT/EP2006/005219, filed Jun. 1, 2006 and German Application No. 10 2005 029 673.4, filed Jun. 22, 2005, the complete disclosures of which are hereby incorporated by reference.

### BACKGROUND OF THE INVENTION

a) Field of the Invention

The invention is directed to a light microscope with an external power supply unit.

b) Description of the Related Art

Conventional microscopes have internal power supply units to supply the electric consumers such as illumination, motors control computers, etc. associated with the microscope. These internal power supply units provide the voltages, in some cases different voltages, for these consumers.

DE 102 55 306 states that this internal power supply unit can also be used to supply external consumers such as cameras or the like.

In case of a defective power supply unit, the microscope must be disassembled and repaired in a time-consuming manner.

It is known from the DV4 stereo microscope of the present applicant to use an external power supply unit instead of the internal power supply unit for supplying the microscope with the correct working voltage via a connection cable. This power supply unit is constructed as a so-called plug-in power supply unit, that is, the electronics of the power supply unit are integrated in the plug as is known, e.g., from DE 101 02 713 B4 or DE 100 01 525 A1.

However, the use of an external power supply unit has the disadvantage that the power supply unit is often mislaid, especially when the microscope is not in use, or is misused for other electrical appliances. This is especially easy in that these power supply units are standardized in principle and are accordingly interchangeable.

### OBJECT AND SUMMARY OF THE INVENTION

It is the primary object of the invention to overcome the above-described disadvantages of the prior art and to provide a convenient solution for accommodating an external power supply unit.

According to the invention, this object is met in a microscope comprising an external power supply unit. The microscope further has a receptacle for mechanically attaching the power supply unit in a removable manner.

The microscope according to the invention has a receptacle in which the external power supply unit can be removably fastened. This receptacle is advantageously shaped as a cutout in the microscope stand so that the power supply unit adapts to the outer shape of the microscope when seated in the receptacle. It is advantageous when the microscope stand also has a compartment for the connection cable. In a particularly simple solution, the receptacle for the power supply unit has corresponding mating pieces for the plug contacts of the power supply unit. However, within the meaning of the invention, any other frictionally engaging or positively engaging connection may also be provided for holding the power supply unit at the microscope.

Further, it is advantageous when the power supply unit can be locked in the receptacle by means of a key or special tool in order to prevent unauthorized use or unauthorized removal of the power supply unit.

The invention will be described more fully in the following with reference to a preferred embodiment example.

### BRIEF DESCRIPTION OF THE DRAWINGS

In the drawings:

FIG. 1 shows a view of the microscope with the power supply unit located in the receptacle;

FIG. 2 shows details of the receptacle for the power supply unit; and

FIG. 3 shows the power supply unit removed.

### DESCRIPTION OF THE PREFERRED EMBODIMENTS

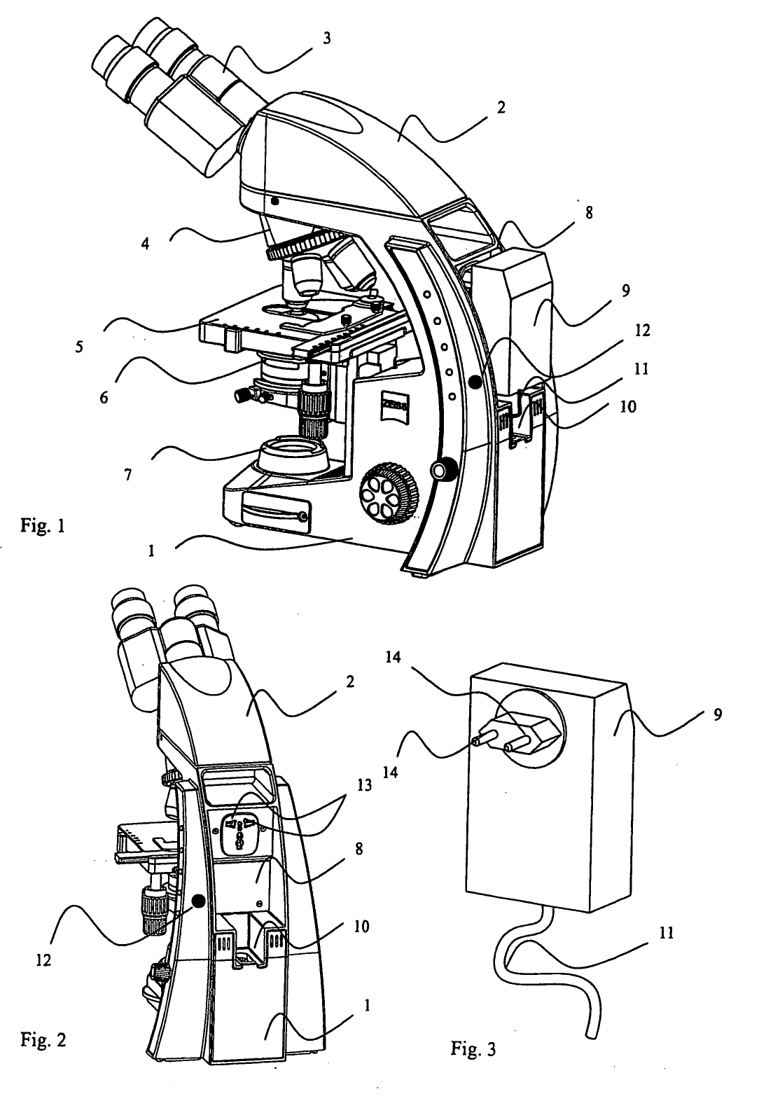

FIG. 1 shows a microscope with a stand 1, tube 2, binocular part 3, objective turret 4, object stage 5, condenser 6, and transmitted light illumination 7. In the rear portion of the stand 1, a receptacle 8 is provided for a power supply unit 9. The receptacle 8 has a compartment 10 for the connection cable 11 of the power supply unit 9. FIG. 1 shows the ready-to-transport microscope with the power supply unit 9 stored in the receptacle. A lock mechanism 12 can be used to lock the power supply unit 9 in the receptacle 8.

FIG. 2 clearly shows the receptacle 8 with the power supply unit 9 removed. The receptacle has corresponding mating pieces (sockets) 13 for the plug contacts 14 of the power supply unit 9 in the form of a female connector. The power supply unit 9 is already sufficiently locked to the stand 1 by inserting the plug contacts 14 into the mating pieces 13, and this locking can be additionally secured by the lock mechanism 12.

FIG. 3 shows the detached plug-in power supply unit 9 with the connection cable 11 and the plug contacts 14.

The invention is not limited to the embodiment example shown herein. Further developments by those skilled in the art do not constitute a departure from the protective scope defined by the claims. In particular, a conventional power supply unit with its own connection cable can be used instead of the plug-in power supply unit 9. In this case, the receptacle 8 need only be adapted in a corresponding manner and an additional compartment provided for this second connection cable.

While the foregoing description and drawings represent the present invention, it will be obvious to those skilled in the art that various changes may be made therein without departing from the true spirit and scope of the present invention.

1-6. (canceled)

7. A microscope comprising:
an external power supply unit;
said microscope further having a receptacle for mechanically attaching the power supply unit in a removable manner.

8. The microscope according to claim 7, wherein the receptacle is realized as a cutout in the microscope stand.

9. The microscope according to claim 7, wherein a compartment is provided for the connection cable of the power supply unit.

10. The microscope according to claim 7, wherein the microscope holds the power supply unit by frictional engagement or positive engagement.

11. The microscope according to claim 10, wherein the power supply unit is constructed as a plug-in power supply unit and a positive engagement with the microscope is realized by a socket adapted to the plug of the power supply unit.

12. The microscope according to claim 7, wherein the power supply unit is secured in the holder by additional locking.
